(19) United States
(12) Patent Application Publication
(10) Pub. No.: US 2022/0363842 A1
(43) Pub. Date: Nov. 17, 2022

(54) FILLED POLYARYL ETHER KETONE POWDER, MANUFACTURING METHOD THEREFOR AND USE THEREOF

(71) Applicant: Arkema France, Colombes (FR)

(72) Inventors: Benoît BRULE, Serquigny (FR); Philippe BUSSI, Colombes Cedex (FR)

(73) Assignee: Arkema France, Colombes (FR)

(21) Appl. No.: 17/767,092

(22) PCT Filed: Oct. 7, 2020
(86) PCT No.: PCT/FR2020/051759

§ 371 Date: Apr. 7, 2022

(30) Foreign Application Priority Data
Oct. 8, 2019 (FR) 1911127

(51) Int. Cl. C08J 3/12; C08K 3/013; C08K 3/34; B33Y 10/00; B33Y 70/00; B29C 64/153; B29B 9/10; B29B 9/12; B33Y 40/10; B29C 64/314; B29B 9/16

(52) U.S. Cl. CPC C08J 3/12; C08K 3/013; C08K 3/346; B33Y 10/00; B33Y 70/00; B29C 64/153; B29B 9/10; B29B 9/12; B33Y 40/10; B29C 64/314; B29B 9/16; C08J 2371/00; B29K 2071/00

(57) ABSTRACT

A powder with a volume-weighted particle size distribution, with a median diameter D50 ranging from 40 to 120 micrometers, including at least one polyaryl ether ketone and at least one filler, in which: said at least one polyaryl ether ketone forms a matrix incorporating, at least partly, said at least one filler, and said filler has a Stokes equivalent spherical diameter distribution with a median diameter d′50 of less than or equal to 5 micrometers. Also a powder manufacturing process and the use thereof in a process for the layer-by-layer construction of objects by electromagnetic radiation-mediated sintering.

### TECHNICAL FIELD

The invention relates to the field of polyaryl ether ketone powders.

More particularly, the invention relates to a filled polyaryl ether ketone powder, to a process for manufacturing the powder and also to the use thereof in a process for manufacturing three-dimensional objects, notably in a powder sintering process mediated by electromagnetic radiation.

### PRIOR ART

Polyaryl ether ketones (PAEKs) are well-known high-performance technical polymers. They may be used for applications which are restrictive in terms of temperature and/or in terms of mechanical constraints, or even chemical constraints. They may also be used for applications requiring excellent fire resistance and little emission of fumes or of toxic gases. Finally, they have good biocompatibility. These polymers are found in fields as varied as the aeronautical and aerospace sector, offshore drilling, motor vehicles, the railroad sector, the marine sector, the wind power sector, sport, construction, electronics or medical implants. They may be used in all the technologies in which thermoplastics are used, such as molding, compression, extrusion, spinning, powder coating or sinter prototyping.

Processes of layer-by-layer construction of objects by sintering mediated by electromagnetic radiation, notably by infrared radiation and laser radiation, are well known to those skilled in the art. With reference to FIG. 1, the laser sintering device 1 comprises a sintering chamber 10 in which are placed a feed tank 40 containing the powder to be sintered, a horizontal plate 30 for supporting the three-dimensional object 80 under construction and a laser 20. Powder is taken from the feed tank 40 and deposited on the horizontal plate 30, forming a thin layer 50 of powder constituting the three-dimensional object 80 under construction. A compacting roller/doctor blade (not shown) ensures good uniformity of the powder layer 50. The powder layer 50, under construction, is heated by means of infrared radiation 100 to reach a substantially uniform temperature equal to a predetermined construction temperature Tc. In conventional PAEK-based powder sintering construction processes, Tc is generally about 20° C. below the melting point of the powder. In certain cases, Tc may even be lower. The energy required to sinter the powder particles at various points in the powder layer 50 is then provided by laser radiation 200 from the laser 20 that is movable in the plane (xy), in a geometry corresponding to that of the object. The molten powder resolidifies forming a sintered part 55, whereas the rest of the layer 50 remains in the form of unsintered powder 56. Several passes of laser radiation 200 may be necessary in certain cases. Next, the horizontal plate 30 is lowered along the axis (z) by a distance corresponding to the thickness of one layer of powder, and a new layer is deposited. The laser 20 supplies the energy required to sinter the powder particles in a geometry corresponding to this new slice of the object, and so on. The procedure is repeated until the entire object 80 has been manufactured. Once the object 80 has been completed, it is removed from the horizontal plate 30 and the unsintered powder 56 can be screened before being returned, where appropriate, into the feed tank 40 to serve as recycled powder.

In order to improve the mechanical properties, notably in order to increase the modulus of elasticity, objects manufactured from polyaryl ether ketone powder, notably objects manufactured by electromagnetic radiation-mediated sintering, it is known practice to add carbon fibers to the polyaryl ether ketone powder.

The carbon fibers may be dry-blended with polyaryl ether ketone particles. For example, US 2018/0201783 describes a composition obtained from the dry blending of polyether ketone ketone particles with carbon fibers having a median length strictly greater than the mean diameter of the particles. More precisely, the blend produced comprises 85% by weight of polyether ketone ketone particles with a median diameter of 61.34 μm, measured using a Coulter Counter particle counter according to the standard ISO 13319, and 15% by weight of carbon fibers with a median length L50 equal to 77 μm and an approximate diameter equal to 7.1 μm. The blend is introduced into a high-intensity mixer in order to partially incorporate at least a portion of the carbon fibers into the polyether ketone ketone particles. The dry blend of polyether ketone ketone particles with carbon fibers has the advantage of being particularly easy to prepare.

Dry-blending of carbon fibers with polyaryl ether ketone particles nevertheless has several drawbacks.

A first drawback is that the three-dimensional objects obtained from the laser sintering of these powders have anisotropic mechanical properties, i.e. properties which differ depending on whether the object is viewed along the Z axis on which the various layers have been printed or whether it is viewed along the XY plane in which each layer has been printed. The reason for this is that the carbon fibers have a tendency to align along a favored direction during the passage of the compacting roller/doctor blade.

A second drawback is that it is not possible to use a large proportion of carbon fibers in the powder for fear of impairing the flowability of said powder, good flowability being necessary for use in laser sintering. Specifically, given that it is very difficult to incorporate the carbon fibers into the polyether ketone ketone particles, a large proportion of carbon fibers in the composition entrains only a small proportion which manage to become sufficiently incorporated into the polyether ketone ketone particles, which implies that a majority of the carbon fibers remain free in the composition, thus impairing the flowability of the powder. In addition, the freshening of the powder, i.e. its at least partial recycling, after screening, into the construction of another object by laser sintering is not readily achievable on account of the difficulties in conserving a constant content of carbon fibers in the polyether ketone ketone powder. Patent application US 2018/0201783 indicates a proportion ranging from 5% to 30% by weight of carbon fibers in the dry blend, bearing in mind that, at the present time, the dry blends of polyether ketone ketone particles with carbon fibers available on the market have a carbon fiber proportion generally not exceeding 15% by weight of composition. In order for the three-dimensional objects obtained from laser sintering to have substantially isotropic mechanical properties, powders in which the carbon fibers are incorporated into polyaryl ether ketone particles are known. For example, patent application US 2005/0207931 describes polyether ether ketone particles incorporating carbon fibers, the polyether ether ketone forming a matrix, and the carbon fibers being essentially incorporated into the matrix. The “mean diameter D50” (measuring method not detailed) is between 20 μm and 150 μm. The mean length of the carbon fibers is also between 20 and 150 μm.

Patent application US 2005/0207931 describes three methods for preparing thermoplastic particles incorporating more than 30% by weight of carbon fibers (see variant 3).

The first manufacturing method described is spray-drying. This method consists in mixing in a liquid phase, such as ethanol or a water/ethanol mixture, a thermoplastic micropowder with a D50 of between 3 μm and 10 μm, with carbon fibers. The suspension is sprayed onto a surface, and the liquid phase of the suspension is then vaporized or evaporated so as to form a powder.

The second method consists in milling thermoplastic granules with an initial grain size of 3 mm, into which the carbon fibers are already incorporated. The milling takes place under cryogenic conditions in a mill equipped with pin discs until the particles reach the desired size and are separated by means of an air separator. The third manufacturing method is melt-spraying. This method consists in spraying a mixture of carbon fibers and of molten thermoplastic to obtain particles with sizes of the order of a few tens of micrometers.

These three methods may prove to be very difficult to perform, especially in the case where the thermoplastic is a polyaryl ether ketone like polyether ether ketone. In the case where they may be reasonably performed with a polyaryl ether ketone as thermoplastic, the powder charged with polyaryl ether ketone which would be obtained would have a very high cost price. In particular, the first method appears to be very difficult to perform due to the complexity and the high cost for obtaining polyaryl ether ketone particles with a size of the order of a few micrometers used in the starting powder. The second method also appears to be complicated to perform due to the presence of carbon fibers in the granules to be milled, which has a tendency to cause high abrasion and accelerated aging of the mill. Furthermore, in the second method, the size of the carbon fibers incorporated into the polyaryl ether ketone particles is controlled by the particle size and generally cannot be greater than the particle size. Finally, the third method is also complicated to perform since correct manufacture of the powder is subject to non-agglomeration of the particles of the spray, which is reflected in particular by a need for an extremely rapid and precise cooling system.

As a result, powder compositions comprising a polyaryl ether ketone, forming a matrix, and carbon fibers essentially incorporated into the matrix, have a much higher cost price than dry blends of polyaryl ether ketone particles and of carbon fibers. In addition, the reinforcement obtained in the three-dimensional objects is generally lower for those which have been obtained by laser sintering of a composition of PAEK particles incorporating carbon fibers in comparison with those obtained by laser sintering of dry blends of PAEK particles and of carbon fibers. This is notably explained by the fact that, in the first case, the size of the carbon fibers is generally controlled by the particle size, which is not the case in the second case, where the carbon fibers may be much longer.

Thus, there is a need to develop alternative filled polyaryl ether ketone powders for improving the mechanical properties, notably for increasing the modulus of elasticity, or even the breaking stress, of objects manufactured from these powders, notably objects manufactured by electromagnetic radiation-mediated sintering.

There is also a need to develop optimized processes for obtaining these filled powders.

### OBJECTS OF THE INVENTION

The object of the invention is thus to propose a filled powder and a process for manufacturing this powder, which overcome at least some of the drawbacks of the prior art.

One object of the invention is notably to propose a filled powder based on polyaryl ether ketone(s) which leads to objects with better mechanical properties, notably a higher modulus of elasticity and a higher breaking stress, than an unfilled powder based on polyaryl ether ketone(s).

Another object of the invention is to propose a filled powder based on polyaryl ether ketone(s) which leads to objects whose mechanical properties are substantially isotropic.

According to certain embodiments, one object is to propose a filled powder which has a relatively low cost price.

According to certain embodiments, one object is to propose a powder which leads to objects which have mechanical properties that are similar to or even better than those of powders based on polyaryl ether ketone(s) comprising carbon fibers (dry blend with fibers or incorporated fibers).

According to certain embodiments, an object is to propose a powder which can be used in an electromagnetic radiation-mediated powder sintering process and which can, where appropriate, be readily recycled into one or more subsequent constructions.

Another object of the invention is also to propose a process for manufacturing the powder according to the invention, which is simple and which has a relatively low cost price.

### SUMMARY OF THE INVENTION

The invention relates to a powder having a volume-weighted particle size distribution, measured by laser diffraction, according to the standard ISO 13320: 2009, with a median diameter D50 ranging from 40 to 120 micrometers.

The powder comprises at least one polyaryl ether ketone (PAEK) and at least one filler, in which:
said at least one polyaryl ether ketone forms a matrix incorporating said at least one filler, and
said filler has a Stokes equivalent spherical diameter distribution, measured by X-ray with gravitational liquid sedimentation, according to the standard ISO 13317-3: 2001, with a median diameter d′50 of less than or equal to 5 micrometers.

The term “D50” means the powder particle diameter value such that the cumulative volume-weighted particle diameter distribution function is equal to 50%. “D50” is measured by laser diffraction according to the standard ISO 13320: 2009, for example using a Malvern Mastersizer 2000® diffractometer.

The term “D′50” means the filler particle diameter value such that the cumulative volume-weighted particle diameter distribution function is equal to 50%. “D′50” is measured by laser diffraction according to the standard ISO 13320: 2009, for example using a Malvern Mastersizer 2000® diffractometer.

The term “d′50” means the filler particle diameter value such that the cumulative Stokes equivalent spherical diameter distribution function is equal to 50%. “d′50” is measured by gravity sedimentation in a liquid according to the standard ISO 13317-3: 2001, for example in a Sedigraph III Plus® machine.

The standard ISO 9276 is used for mathematical and statistical modeling for calculating the particle size distribution.

For filler particles of substantially spherical shape, D′50 and d′50 are substantially equal. For filler particles of nonspherical shape, notably for particles of flattened shape and/or of elongated shape, which may be described by a characteristic length and a characteristic thickness, a shape coefficient C is defined by the following formula:

$$C = \frac{{D}^{′} 50 - {d}^{′} 50}{{d}^{′} 50}$$

The term “Z axis” means the direction in which the various layers are printed in a layer-by-layer electromagnetic radiation-mediated powder sintering process. In contrast, the term “XY” means the plane in which each layer is printed.

The inventors of the present invention have noted, surprisingly, that the powder as claimed makes it possible to manufacture three-dimensional objects via a layer-by-layer construction of objects by an electromagnetic radiation-mediated sintering process, having mechanical properties that are superior to those of objects manufactured from unfilled powder based on polyaryl ether ketone(s). Specifically, the powder comprising PAEK(s) and incorporating a filler whose d′50 is sufficiently smaller than the D50 of the powder notably makes it possible to obtain three-dimensional objects by laser sintering which have higher stiffness and/or a higher breaking strength.

The inventors were also able to demonstrate that, in certain embodiments, the powder according to the invention makes it possible to manufacture three-dimensional objects via a process of layer-by-layer construction of objects by electromagnetic radiation-mediated sintering, which objects have mechanical properties (notably a breaking strength and an elongation at break) similar in magnitude to, or even greater than, those of objects obtained from powder based on polyaryl ether ketone(s) and carbon fibers (dry-blending of the fibers or incorporation of the fibers into a matrix).

In addition, the mechanical properties of the three-dimensional objects manufactured from the powder according to the invention are isotropic or quasi-isotropic, i.e. equivalent in all spatial directions.

According to certain embodiments, the filler has a particle size distribution with a median diameter d′50 of less than or equal to 2.5 micrometers.

According to certain embodiments, the mass ratio of the filler to said at least one PAEK is from 1:9 to 1:1.

For a mass ratio of less than 1:9, the gain in mechanical properties, notably the increase in the elastic modulus value, of an object manufacture from the powder is generally not substantial relative to an object manufactured from unfilled powder. For a mass ratio of greater than 1:1, the object manufactured from the powder is generally too brittle.

Preferentially, the mass ratio of the filler to said at least one PAEK is from 1:4 to 3:7.

In certain embodiments, said at least one PAEK and said at least one filler together represent at least 60%, or at least 70%, or at least 80%, or at least 85%, or at least 90%, or at least 92.5%, or at least 95%, or at least 97.5%, or at least 98%, or at least 98.5%, or at least 99% or at least 99.5% or 100% of the total weight of the powder.

In certain embodiments, the PAEK is a statistical copolymer of polyether ketone ketone (PEKK), consisting essentially of, preferentially consisting of, a terephthalic unit and an isophthalic unit,

the formula of the terephthalic unit (T) being:

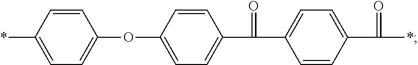

the formula of the isophthalic unit (I) being:

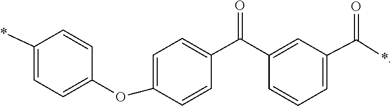

In certain embodiments, the mass percentage of terephthalic units relative to the sum of the terephthalic and isophthalic units is from 55% to 65%. Preferentially, the mass percentage of terephthalic units relative to the sum of the terephthalic and isophthalic units is about 60%.

In certain embodiments, said at least one PAEK is a copolymer consisting essentially of, preferentially consisting of:
unit(s) of formula: -Ph-O-Ph-O-Ph-C(O)—; and
unit(s) of formula: -Ph-O-Ph-Ph-O-Ph-C(O)—;

in which Ph represents a phenylene group and —C(O)— represents a carbonyl group, each of the phenylenes possibly being, independently, of the ortho, meta or para type, preferentially of meta or para type.

According to certain embodiments, the filler is a mineral filler. Said filler may preferentially be chosen from the group consisting of: calcium carbonate, silica, talc, wollastonite, mica, kaolin, and a mixture thereof. More preferably, said filler is a talc. Talc has the advantage of having a low cost price and of affording advantageous reinforcing properties for an object obtained from a powder according to the invention.

In certain embodiments, said filler has a shape coefficient C of greater than or equal to 2, said shape coefficient C being defined by the following formula:

$$C = \frac{{D}^{′} 50 - {d}^{′} 50}{{d}^{′} 50} ;$$

in which D′50 denotes the volume-weighted median diameter of the filler particles, measured according to the standard ISO 13320: 2009 and

in which d′50 denotes the median Stokes equivalent spherical diameter of the filler particles, measured by X-ray with gravitational liquid sedimentation, according to the standard ISO 13317-3: 2001.

The present invention also relates to a powder manufacturing process comprising the steps consisting in:
supplying at least one polyaryl ether ketone (PAEK) and supplying at least one filler,
said at least one filler having a Stokes equivalent spherical diameter distribution, measured by X-ray with gravitational liquid sedimentation, according to the standard ISO 13317-3: 2001, with a median diameter d′50 of less than or equal to 5 micrometers;
extrusion-granulation of said at least one polyaryl ether ketone (PAEK) with said at least one filler so as to form granules; and
milling of the granules to obtain a powder having a volume-weighted particle size distribution, measured by laser diffraction, according to the standard ISO 13320: 2009, with a median diameter D50 ranging from 40 to 120 micrometers.

The inventors of the present invention have noted that, surprisingly, the milling of granules based on PAEK(s) incorporating a filler having a d′50 of less than or equal to 5 micrometers makes it possible to facilitate the milling when compared with granules based on PAEK(s) incorporating carbon fibers. The selection of a filler having a d′50 of less than or equal to 5 micrometers notably makes it possible readily to obtain powders with a D50 ranging from 40 to 120 micrometers. The milling time is thus short. In addition, the granules based on PAEK(s) incorporating a filler having a d′50 of less than or equal to 5 micrometers are generally much less abrasive during milling than granules based on PAEK(s) incorporating carbon fibers of the prior art. The mill is thus not subjected to excessive abrasion.

In certain embodiments, the process also comprises a heat treatment of the granules before the milling step to enable at least partial crystallization of said at least PAEK of the powder.

The present invention also relates to a process for the layer-by-layer construction of objects by electromagnetic radiation-mediated sintering, in which a powder according to the invention is used. In other words, the invention also relates to the use of the powder described above in a process for the layer-by-layer construction of objects by sintering mediated with at least one electromagnetic radiation.

Finally, the present invention relates to any object which may be obtained via the process for the layer-by-layer construction of objects by electromagnetic radiation-mediated sintering, in which the powder is used. This object is characterized in that it has, in at least one direction, a tensile elastic modulus of greater than or equal to 7 GPa, on a specimen of 1BA type, at 23° C., with a travelling speed of 1 mm/minute, according to the standard ISO 527-2: 2012. Since the mechanical properties of the object are quasi-isotropic, it generally has a tensile elastic modulus of greater than or equal to 7 GPa in all spatial directions, notably in the XY plane and along the Z axis.

### BRIEF DESCRIPTION OF THE FIGURES

FIG. 1 schematically represents a device for performed a process for the layer-by-layer construction of a three-dimensional object by sintering in which the powder according to the invention may be used.

### DETAILED DESCRIPTION OF THE INVENTION

Polyaryl Ether Ketones

The polyaryl ether ketone(s) (PAEK(s)) of the powders according to the invention include units having the following formulae:

(—Ar—X—) and (—Ar₁—Y—),

in which:
Ar and Ar₁ each denote a divalent aromatic radical; Ar and Ar₁ may preferably be chosen from 1,3-phenylene, 1,4-phenylene, 4,4′-biphenylene, 1,4-naphthylene, 1,5-naphthylene and 2,6-naphthylene;
X denotes an electron-withdrawing group; it may preferably be chosen from the carbonyl group and the sulfonyl group;
Y denotes a group chosen from an oxygen atom, a sulfur atom or an alkylene group, such as —(CH)₂— and isopropylidene.

In these units X and Y, at least 50%, preferably at least 70% and more particularly at least 80% of the groups X are a carbonyl group, and at least 50%, preferably at least 70% and more particularly at least 80% of the groups Y represent an oxygen atom.

According to a preferred embodiment, 100% of the groups X denote a carbonyl group and 100% of the groups Y represent an oxygen atom.

Advantageously, the PAEK(s) of the powders may be chosen from:
a polyether ketone ketone, also known as PEKK; a PEKK comprises one or more units of formula: -Ph-O-Ph-C(O)-Ph-C(O)—;
a polyether ether ketone, also known as PEEK; a PEEK comprises one or more units of formula: -Ph-O-Ph-O-Ph-C(O)—;
a polyether ketone, also known as PEK; a PEK comprises one or more units of formula: -Ph-O-Ph-C(O)—;
a polyether ether ketone ketone, also known as PEEKK; a PEEKK comprises one or more units of formula: -Ph-O-Ph-O-Ph-C(O)-Ph-C(O)—;
a polyether ether ether ketone, also known as PEEEK; a PEEEK comprises one or more units of formula: -Ph-O-Ph-O-Ph-O-Ph-C(O)—;
a polyether diphenyl ether ketone, also known as PEDEK; a PEDEK comprises one or more units of formula: -Ph-O-Ph-Ph-O-Ph-C(O)—;
mixture(s) thereof; and
copolymer(s) thereof.

In the formulae of the units of the above list, Ph represents a phenylene group and —C(O)— represents a carbonyl group, each of the phenylenes possibly being, independently, of the ortho (1-2), meta (1-3) or para-(1-4) type, preferentially of meta or para type.

In addition, defects, end groups and/or monomers may be incorporated in very small amount into the polymers as described in the above list, without, however, having an incidence on their performance.

In certain embodiments, said at least one PAEK is a PEKK. The PEKK may be a copolymer consisting essentially of, preferentially consisting of, “I type” (“isophthalic type”) units, of formula:

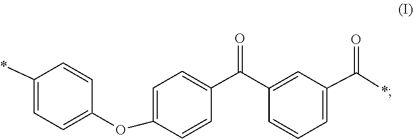

and “T type” (“terephthalic type”) units, of formula:

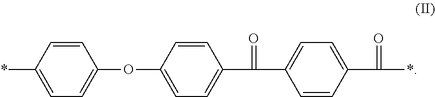

The mass proportion of T units, relative to the sum of the T and I units of the PEKK(s), may range from 0% to 5%; or from 5% to 10%; or from 10% to 15%; or from 15% to 20%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%. The choice of the mass proportion of T units relative to the sum of the T and I units is one of the factors which makes it possible to adjust the melting point and the rate of crystallization at a given temperature of the PEKK. A given mass proportion of T units relative to the sum of the T and I units can be obtained by adjusting the respective concentrations of the reagents during the polymerization, in a manner known per se.

According to advantageous embodiments, the sum of the terephthalic and isophthalic units in the PEKK is from 55% to 65%; preferentially, the mass percentage of terephthalic units relative to the sum of the terephthalic and isophthalic units is about 60%.

In certain embodiments, said at least one PAEK is a PEEK-PEDEK copolymer. The PEEK-PEDEK copolymer may consist essentially of, and preferentially may consist of, units of formula:

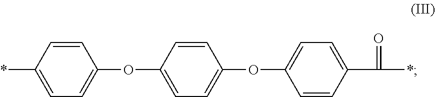

and

units of formula:

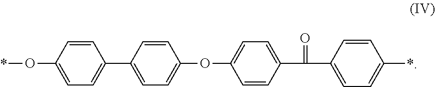

The molar proportion of units (III), relative to the sum of the units (III) and (IV) of PEEK-PEDEK, may range from 0% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%. The choice of the molar proportion of units (III) relative to the sum of the units (III) and (IV) is one of the factors which makes it possible to adjust the melting point and the rate of crystallization at a given temperature of the PEEK-PEDEK copolymer. A given molar proportion of units (III) relative to the sum of the units (III) and (IV) may be obtained by adjusting the respective concentrations of the reagents during the polymerization, in a manner known per se.

The viscosity index of the PAEK(s), measured as a solution at 25° C. in aqueous sulfuric acid solution at 96% by mass according to the standard ISO 307: 2019, may be from 0.65 dl/g to 1.15 dl/g, preferentially from 0.70 dl/g to 1.05 dl/g and more preferably from 0.70 dl/g to 0.92 dl/g.

Fillers

The at least one filler in the powder according to the invention has a Stokes equivalent spherical diameter distribution, measured by X-ray with gravitational liquid sedimentation, according to the standard ISO 13317-3: 2001, with a median diameter d′50 of less than or equal to 5 micrometers.

The filler may notably have a particle size distribution with a median diameter d′50 of less than or equal to 2.5 micrometers. In certain cases, the filler may have a median diameter d′50 of less than or equal to 2 micrometers, or less than or equal to 1.5 micrometers, or alternatively less than or equal to 1 micrometer. The median diameter d′50 of the filler is generally not less than 0.1 micrometer.

In certain embodiments, the median diameter d′50 is from 0.1 to 5.0 micrometers, or from 0.25 to 4.0 micrometers, or alternatively from 0.5 to 3.0 micrometers. The median diameter d′50 may notably be from 0.1 to 0.5 micrometer, or from 0.5 to 1.0 micrometer, or from 1.0 to 1.5 micrometers; or from 1.5 to 2.0 micrometers; or from 2.0 to 2.5 micrometers, or from 2.5 to 3.0 micrometers, or from 3.0 to 3.5 micrometers, or from 3.5 to 4.0 micrometers, or from 4.0 to 4.5 micrometers, or alternatively from 4.5 to 5.0 micrometers.

Advantageously, the filler is a mineral filler.

Advantageously, the filler is a reinforcing filler, i.e. a filler which can improve the stiffness, notably the tensile elastic modulus and/or the breaking strength of said at least one polyaryl ether ketone (PAEK).

The filler may comprise a calcium carbonate (calcite).

The filler may also comprise a silica. The filler may notably be pure silica (SiO₂), a synthetic silica, a quartz or a diatomaceous flour.

The filler may also comprise a talc.

The filler may also comprise a wollastonite.

Finally, the filler may comprise a clay or an aluminosilicate. The filler may notably be a kaolin, a slate flour, vermiculite or a mica.

The filler is advantageously a talc. Talc has the advantage of having a low cost price and of affording advantageous reinforcing properties for an object obtained from a powder according to the invention.

The filler is preferentially nonspherical. It may be characterized by its shaped coefficient C, C advantageously being greater than or equal to 2. The shape coefficient C is generally not greater than 20.

Powder Manufacturing Process

In the process for manufacturing powders according to the invention, the polyaryl ether ketone(s) and the filler(s) are blended and then extruded.

According to a first embodiment, the at least one filler and the at least one polyaryl ether ketone are dry-blended and introduced into the main hopper of the extruder. According to a more advantageous second embodiment, the at least one polyaryl ether ketone is introduced into the main hopper whereas the at least one filler is introduced by side feeding and added to the molten polyaryl ether ketone. This has the advantage of preventing the filler(s) from being excessively damaged during their passage through the extruder.

Any extruder suitable for the extrusion of high-melting polymers may be used. A person skilled in the art is, furthermore, capable of adapting the extrusion conditions as a function of the polymer used. An example of an extruder is a “Labtech” twin-screw extruder with a screw diameter of 26 mm and an L/D ratio of 40.

The extruded mixture is subdivided so as to form granules.

The granules are then optionally heat-treated so as to increase the crystallinity of the polyaryl ether ketone(s). The reason for this is that high crystallinity of the granules makes it possible to facilitate the following milling step. Advantageously, the fraction of the PAEK in the powder has a heat of fusion, measured on the first heating and using a heating rate of 20° C./minute according to the standard ISO 11357-2: 2013, ranging from 20 to 50 J/g (PAEK), preferentially ranging from 25 to 40 J/g (PAEK).

The heat treatment is advantageously performed at a much lower temperature than the melting point of the powder. According to a variant in which the powder is a powder based on PEKK with a mass percentage of terephthalic units relative to the sum of the terephthalic and isophthalic units of from 55% to 65%, the heat treatment may be performed at a temperature of from 180° C. to 220° C.

The granules are then milled to a powder so as to obtain a powder having a particle size distribution with a median diameter D50 ranging from 40 to 120 micrometers. The granules according to the invention are more brittle than PAEK granules incorporating carbon fibers (for the same volume content of filler): the milling step is thereby facilitated. In addition, the PAEK granules incorporating a filler, advantageously a talc, having a d′50 of less than or equal to 5 micrometers are generally much less abrasive during milling than PAEK granules incorporating carbon fibers.

The milling may be performed at a temperature below −20° C., preferentially at a temperature below −40° C., by cooling with liquid nitrogen, or liquid carbon dioxide, or cardice, or liquid helium. The mill used is advantageously a pin mill, notably a counter-rotating pin mill, or alternatively an impact mill, such as a hammer mill, or alternatively a vortex mill. The mill may be equipped with a screen onto which the milled particles are sent, the particles passing through the screen having the desired size. The particles retained by the screen may be conveyed back into the mill to undergo longer milling.

Powders

The mass ratio of the at least one filler to the at least one PAEK may be from 1:9 to 1:1. For a mass ratio of less than 1:9, the gain in mechanical properties, notably the increase in the elastic modulus value, of an object manufacture from the powder is generally not substantial relative to an object manufactured from unfilled PAEK powder. For a mass ratio of greater than 1:1, the object manufactured from the powder is generally too brittle. The mass ratio of the at least one filler to the at least one PAEK is advantageously from 1:4 to 3:7.

The mass ratio of the at least one filler to the at least one PAEK may also be from 3:7 to 2:3, or alternatively from 2:3 to 1:1.

The PAEK(s) and the filler(s) together represent at least 60%, or at least 70%, or at least 80%, or at least 85%, or at least 90%, or at least 92.5%, or at least 95%, or at least 97.5%, or at least 98%, or at least 98.5%, or at least 99% or at least 99.5% or 100% of the total weight of the powder.

In addition to the PAEK(s) and the filler(s), the powder may comprise another polymer not belonging to the PAEK family, notably other thermoplastic polymers. The powder may also comprise additives. Among the additives, mention may be made of flow agents, stabilizers (light, in particular UV, and heat stabilizers), optical brighteners, dyes, pigments and energy-absorbing additives (including UV absorbers). The additives generally represent less than 5% by weight relative to the total weight of powder, and preferably represent less than 1% by weight relative to the total weight of powder.

Use of the Powders

The powders according to the invention may be used in numerous applications, including the nonexhaustive applications below.

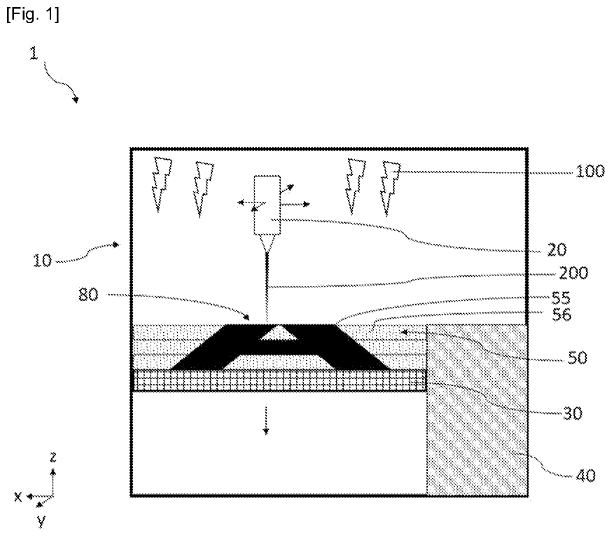

The powders according to the invention may be used in processes for the electromagnetic radiation-mediated layer-by-layer sintering construction of objects. An infrared radiation and laser radiation sintering process is illustrated in FIG. 1 and has already been described in the section dealing with the prior art. The powders according to the invention may also be used in processes for coating metal surfaces. Various processes may be used in order finally to obtain a coating on metal parts. Mention may be made of dipping in the fluidized bed for which the metal part is heated and then dipped into the fluidized powder bed. It is also possible to perform electrostatic powder coating (charged powder dusted onto an earthed metal part); in this case, a thermal post-treatment is performed to produce the coating. An alternative is to perform the powder coating on a preheated part, which makes it possible to remove the heat treatment after powder coating. Finally, it is possible to perform flame powder coating; in this case, the powder is melt-sprayed onto an optionally preheated metal part.

The powders according to the invention may also be used in powder compression processes. These processes are generally used for producing thick parts. In these processes, the powder is first loaded into a mold, compacted and then melted to produce the part. Finally, suitable cooling (usually relatively slow) is performed to eliminate the internal stresses in the part.

Experimental Data

The powders of the examples below were manufactured by compounding (extrusion-granulation) of various compositions, heat treatment and then milling. The compounding was performed on a “Labtech” twin-screw extruder having a screw diameter of 26 mm and an L/D ratio of 40, with a flat temperature profile at 350° C. and a screw speed of 400 rpm. Granules with a length equal to about 2 mm were obtained.

In the case of manufacturing filled powders (carbon fibers or talc), the fillers are introduced during the compounding by side feeding. The granules obtained are termed as being “filled”.

The granules were subsequently heat treated for 9 hours at 180° C.

Finally, the heat-treated granules were milled in a Mikropull 2DH® cryogenic hammer mill cooled with liquid nitrogen, the mill furthermore being equipped with a grate with 500-μm round holes.

### Example 1 (Comparative)

The first composition used is a polyether ketone ketone with a mass proportion of T units relative to the sum of the T and I units of 60%, with a viscosity index of 0.75 dl/g at 25° C., in an aqueous sulfuric acid solution at 96% by mass, according to the standard ISO 307: 2019 applied to a PAEK. This polyether ketone ketone is sold by the company Arkema under the name Kepstan®.

The granules obtained with the composition according to example 1 were able to be milled to obtain a D50, measured using a Malvern Mastersizer 2000® diffractometer, of 500 microns.

### Example 2 (Comparative)

The second composition used consists of the polyether ketone ketone according to example 1 and of carbon fibers, the carbon fibers representing 23% by weight of the composition.

The carbon fibers used were Tenax®-A fibers, of “HT M100” type, i.e. fibers with fiber lengths of between 60 micrometers and 100 micrometers.

The granules obtained with the composition according to example 2 were able to be milled to obtain a D50, measured using a Malvern Mastersizer 2000® diffractometer, of 160 microns.

### Example 3 (According to the Invention)

The third composition used consists of the polyether ketone ketone according to example 1 and of Jetfine® 0.7C talc sold by the company Imerys, the talc representing 30% by weight of the composition (so as to ensure a volume proportion of filler equivalent to that of example 2).

Jetfine® 0.7C talc has a d′50, measured on a Sedigraph III Plus® machine, of 0.7 micron and a D′50, measured on a Malvern Mastersizer 2000® diffractometer, of 2.5 microns, i.e. a shape coefficient C equal to: 2.6.

The granules obtained with the composition according to example 3 were able to be milled to obtain a D50, measured using a Malvern Mastersizer 2000® diffractometer, of 120 microns.

### Example 4 (According to the Invention)

The third composition used consists of the polyether ketone ketone according to example 1 and of Steaplus® HAR T77 talc sold by the company Imerys, the talc representing 30% by weight of the composition (so as to ensure a volume proportion of filler equivalent to that of example 2).

Steaplus® HAR T77 talc has a d′50, measured on a Sedigraph III Plus® machine, of 2.2 microns and a D′50, measured on a Malvern Mastersizer 2000® diffractometer, of 10.5 microns, i.e. a shape coefficient C equal to: 3.8.

The granules obtained with the composition according to example 4 were able to be milled to obtain a D50, measured using a Malvern Mastersizer 2000® diffractometer, of 110 microns.

The results for the milling of the powders according to examples 3 and 4 (according to the invention) relative to the results for the milling of the powders according to examples 1 and 2 (comparative examples) show that the milling of PEKK granules incorporating a talc filler with a d′50 of less than or equal to 5 micrometers is facilitated in comparison with unfilled PEKK granules or PEKK granules incorporating carbon fibers with the same volume content of filler.

### Example 6 (Comparative)

Specimens of 1BA type, according to the standard ISO 527-2: 2012, were manufactured by laser sintering of 6002 PL® powder sold by the company Arkema, in an EOS P800® printer sold by the company EOS. The powder has a D50 equal to 50 μm, measured using a Malvern Mastersizer 2000® diffractometer, and a viscosity index of 0.96 dl/g at 25° C., in aqueous sulfuric acid solution at 96% by mass, according to the standard ISO 307: 2019 applied to a PAEK. Specimens of 1BA type were constructed along the X, Y and Z axes at a construction temperature of 290° C. and with a laser sintering energy of 28 mJ/mm².

Irrespective of the construction axis of the specimens in the laser sintering machine, a tensile elastic modulus of 4 GPa was measured at 23° C., with a travelling speed of 1 mm/minute, according to the standard ISO 527-2: 2012, using an MTS 810® machine sold by the company MTS Systems Corporation, equipped with a mechanical extensometer.

### Example 7 (According to the Invention)

Specimens of 1BA type, according to the standard ISO 527-2: 2012, were manufactured by injection of the powder according to example 3, with a feed temperature of 320° C., a screw outlet temperature of 340° C., a mold temperature of 80° C. and a cycle time of not more than 1 minute.

A tensile elastic modulus of 9 GPa was measured, at 23° C., with a travelling speed of 1 mm/minute, according to the standard ISO 527-2: 2012, using an MTS 810® machine sold by the company MTS Systems Corporation, equipped with a mechanical extensometer.

It is considered that the elastic modulus value obtained for a specimen manufactured by injection molding is equal to, or even less than, the value that would be determined for a specimen manufactured by laser sintering. Thus, if the specimen had been manufactured by laser sintering, it would necessarily have a tensile elastic modulus of at least 9 GPa.

### Example 8 (According to the Invention)

Specimens of 1BA type, according to the standard ISO 527-2: 2012, were manufactured by injection molding of the powder according to example 4, according to the same protocol as that of example 7.

A tensile elastic modulus of 9 GPa was also measured, according to the same protocol as that of example 7.

Similarly, if the specimen had been manufactured by laser sintering, it would necessarily have a tensile elastic modulus of at least 9 GPa.

The results for the mechanical tests according to examples 7 and 8 (according to the invention) relative to the results for the mechanical tests according to example 6 (comparative example) show that the mechanical properties of objects obtained from PEKK powders incorporating a talc filler with a d′50 of less than or equal to 5 micrometers are higher than those obtained from unfilled PEKK powders.

The results for the mechanical tests according to examples 7 and 8 furthermore suggest that the mechanical properties of objects obtained from PEKK powders incorporating a talc filler with a d′50 of less than or equal to 5 micrometers would be of the same order as, or even greater than, those of objects obtained for powders filled with the carbon fibers, the comparison being made for the same volume content of filler. Specifically, the specifications sheet for the material HT-23®, sold by the company Advanced Laser Materials, indicates a tensile elastic modulus along X of 6.5 GPa, along Y of 6.4 GPa and along Z of 5.8 GPa, the values being measured according to ASTM D638. HT-23® is a polyether ketone ketone powder incorporating 23% of carbon fibers and intended for laser sintering applications in printers such as the EOS P 500® and EOS P 810® machines sold by the company EOS.

1. A powder having a volume-weighted particle size distribution, measured by laser diffraction, according to the standard ISO 13320: 2009, with a median diameter D50 ranging from 40 to 120 micrometers, comprising at least one polyaryl ether ketone (PAEK) and at least one filler, in which:
said at least one polyaryl ether ketone forms a matrix incorporating, at least partly, said at least one filler, and
said filler has a Stokes equivalent spherical diameter distribution, measured by X-ray with gravitational liquid sedimentation, according to the standard ISO 13317-3: 2001, with a median diameter d′50 of less than or equal to 5 micrometers.

2. The powder as claimed in claim 1, in which said filler has a Stokes equivalent spherical diameter distribution with a median diameter d′50 of less than or equal to 2.5 micrometers.

3. The powder as claimed in claim 1, in which the mass ratio of said filler to said at least one PAEK is from 1:9 to 1:1.

4. The powder as claimed in claim 1, in which said at least one PAEK and said at least one filler together represent at least 60% of the total weight of the powder.

5. The powder as claimed in claim 1, in which said at least one PAEK is a statistical copolymer of polyether ketone ketone (PEKK), consisting essentially of a terephthalic unit and an isophthalic unit,
the formula of the terephthalic unit (T) being: 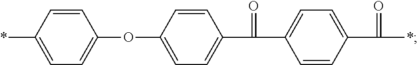
the formula of the isophthalic unit (I) being:

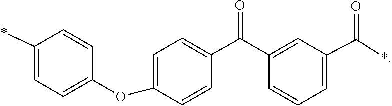

6. The powder as claimed in claim 5, in which the mass percentage of terephthalic units relative to the sum of the terephthalic and isophthalic units is from 55% to 65%.

7. The powder as claimed in claim 1, in which said at least one PAEK is a copolymer consisting essentially of:
unit(s) of formula: -Ph-O-Ph-O-Ph-C(O)—; and
unit(s) of formula: -Ph-O-Ph-Ph-O-Ph-C(O)—,
in which Ph represents a phenylene group and —C(O)— represents a carbonyl group, each of the phenylenes possibly being, independently, of the ortho, meta or para type.

8. The powder as claimed in claim 1, in which said filler is a mineral filler.

9. The powder as claimed in claim 1, in which said filler has a shape coefficient C of greater than or equal to 2, said shape coefficient C being defined by the following formula:
$$C = \frac{{D}^{′} 50 - {d}^{′} 50}{{d}^{′} 50} ;$$
in which D′50 denotes the volume-weighted median diameter of the filler particles, measured according to the standard ISO 13320: 2009 and
in which d′50 denotes the median Stokes equivalent spherical diameter of the filler particles, measured by X-ray with gravitational liquid sedimentation, according to the standard ISO 13317-3: 2001.

10. A powder manufacturing process comprising:
supplying at least one polyaryl ether ketone (PAEK) and supplying at least one filler, said at least one filler having a Stokes equivalent spherical diameter distribution, measured by X-ray with gravitational liquid sedimentation, according to the standard ISO 13317-3: 2001, with a median diameter d′50 of less than or equal to 5 micrometers;
extrusion-granulation of said at least one polyaryl ether ketone (PAEK) with said at least one filler so as to form granules; and
milling of the granules to obtain a powder having a particle size distribution, measured by laser diffraction, according to the standard ISO 13320: 2009, with a median diameter D50 ranging from 40 to 120 micrometers.

11. The process as claimed in claim 10, further comprising:
the heat treatment of the granules before the milling step to enable at least partial crystallization of said at least PAEK.

12. A process for the layer-by-layer construction of objects by electromagnetic radiation-mediated sintering, in which a powder as claimed in claim 1 is used.

13. An object which may be obtained via the process as claimed in claim 12, wherein it has, in at least one direction, a tensile elastic modulus of greater than or equal to 7 GPa, on a specimen of 1BA type, at 23° C., with a travelling speed of 1 mm/minute, according to the standard ISO 527-2: 2012.
